(19) United States
(12) Patent Application Publication
(10) Pub. No.: US 2010/0232666 A1
(43) Pub. Date: Sep. 16, 2010

(54) MEDICAL IMAGE REGISTRATION BY MEANS OF OPTICAL COHERENCE TOMOGRAPHY

(76) Inventors: Alexander URBAN, Forstinning (DE); Alexander Druse, Munich (DE); Fritz Vollmer, Munich (DE)

Correspondence Address: DON W. BULSON (BRAI), RENNER, OTTO, BOISSELLE & SKLAR, LLP, 1621 EUCLID AVENUE - 19TH FLOOR, CLEVELAND, OH, 44115, US

(21) Appl. No.: 12/717,186

(22) Filed: Mar. 4, 2010

Related U.S. Application Data
(60) Provisional application No. 61/158,120, filed on Mar. 6, 2009.

(30) Foreign Application Priority Data
Mar. 5, 2009 (EP) 09154437.9

(51) Int. Cl. G06K 9/00

(52) U.S. Cl. 382/131

(57) ABSTRACT

The invention relates to a medical image registration method in which an actual part of a patient's body is locationally assigned to a stored image of the part of the body with computer assistance, wherein the part of the patient's body comprises a rigid structure and a soft-tissue structure above it, wherein the location of at least one reference point on the rigid structure is ascertained, through the closed soft-tissue structure, by means of optical coherence tomography (OCT), when detecting the actual spatial location of the part of the body. It also relates to a pointer unit of a medical image registration apparatus, which comprises an optical coherence tomography (OCT) scanner or its emitting unit.

### RELATED APPLICATION DATA

This application claims the priority of US Provisional Application No. 61/158,120, filed on Mar. 6, 2009, which is hereby incorporated in its entirety by reference.

### FIELD OF THE INVENTION

The following invention relates to the technical field of medical image registration, in which an actual part of a patient's body is locationally assigned to a stored image of the part of the body with computer assistance, so as to be able to perform an image-guided and/or image-assisted treatment.

### BACKGROUND OF THE INVENTION

There are various ways of registering a patient in such an environment, one of which involves using markers which are scanned and detected during the treatment by means of a medical tracking system. Such a registration method is for example described in DE 196 39 861 A1.

Another type of registration is known from EP 1 142 536 B1, in which the surface of the patient, which has been made detectable using radiated light points, is scanned and assigned to a corresponding surface profile in previously acquired patient image data.

Lastly, a registration system is also known from WO 2008/134236 A1, which operates using a so-called “soft tissue penetrating” laser system.

### SUMMARY OF THE INVENTION

It is the object of the present invention to provide a registration method for a part of a patient's body, which enables high-precision registration but remains non-invasive.

This object is solved by: a medical image registration method in which an actual part of a patient's body is locationally assigned to a stored image of the part of the body with computer assistance, wherein the part of the patient's body comprises a rigid structure and a soft-tissue structure above it, wherein the location of at least one reference point on the rigid structure is ascertained, through the closed soft-tissue structure, by means of optical coherence tomography (OCT), when detecting the actual spatial location of the part of the body; and by a pointer unit of a medical image registration apparatus, with the aid of which an actual part of a patient's body is locationally assigned to a stored image of the part of the body with computer assistance, wherein the pointer unit identifies and/or indicates a reference point for assignment, wherein the pointer unit comprises an optical coherence tomography (OCT) scanner or its emitting unit. The sub-claims define preferred embodiments of the invention.

In the medical image registration method in accordance with the invention, a part of a patient's body which comprises a rigid structure and a soft-tissue structure above it is registered by ascertaining the location of at least one reference point on the rigid structure, through the closed soft-tissue structure, by means of optical coherence tomography (OCT) when detecting the actual spatial location of the part of the body. Using optical coherence tomography, it is possible to measure rigid structures through soft-tissue structures and to ascertain different types of tissue and their location. The present invention has recognized the value of this technology for medical image registration, as well as a suitable implementation by measuring and localizing rigid structures which are situated beneath soft-tissue structures.

In this sense, the invention could also or additionally be regarded as the use of an optical coherence tomograph scanner in localizing and/or measuring rigid structure reference points beneath a soft-tissue structure.

The advantage of measuring and/or detecting reference points on rigid structures is that they can be unambiguously assigned and are not subject to shifting, such as can for example occur with adhered markers on soft tissue or with natural soft-tissue landmarks. The precision of the reference point detection process is also no longer dependent on the surface characteristics of the soft tissue, for example its light reflection characteristics or light adsorption characteristics. This all results in high-precision registration.

In one embodiment of the invention, the actual spatial location of a plurality of reference points, a scatter plot of reference points, linearly adjacent reference points or adjacently spaced reference points is determined, so as to provide an assignable surface image.

The rigid structure can be an osseous structure or a cartilage structure, while the soft-tissue structure can be a skin structure. These examples are not however to be understood as restrictive, because such a restriction follows only from the functionality of the optical coherence tomography scanner. Thus, as long as one layer through which the coherence tomography scanner beam can penetrate (referred to here as the soft tissue) lies above a layer which is impenetrable and reflects the beam (referred to here as the rigid structure), the present method in accordance with the invention and the device in accordance with the invention can be used. This guarantees high-precision registration which is not dependent on the skin characteristics or the position. In optical coherence tomography, monochromatic light is used which exhibits a short coherence and thus allows a detailed depth profile on the part of the patient's body to be acquired. If, for example, a patient's cranium is scanned, in order to match the scan to pre-operatively acquired data, this offers many advantages, because the movement of the scalp is no longer a problem, nor is sweating or the color of the skin. The osseous cranium always corresponds to the pre-operative data captured using an image generating method (CT, MR, etc.). Another advantage is that the light which is used to detect the reference points (the OCT scan) is very near to the infrared range, such that the safety of the patient is ensured.

The method and the pointer unit in accordance with the present invention can in principle also be used to obtain or update image data intra-operatively.

Details of optical coherence tomography and its use in accordance with the invention will be discussed in even more detail below in the explanation of the example embodiment, wherein the characteristics described can of course be implemented in the method in accordance with the invention and/or the device in accordance with the invention individually and in any expedient combination.

In accordance with one embodiment of the method of the present invention, the spatial locations are detected with the aid of a medical, optical tracking system, and registration is in particular performed by a medical navigation system which the tracking system is assigned to. The OCT beam, i.e. the scanning beam of the optical coherence tomography scanner, can be radiated onto the part of the patient's body by the tomography scanner itself or by its emitting unit.

It is possible to ascertain the spatial position of the reference point on the rigid structure, by:

a) spatially detecting the OCT beam reflection point corresponding to it on the outside of the soft-tissue structure, by means of the tracking system; and

b) determining the depth position of the reference point beneath the reflection point, by means of optical coherence tomography.

Additionally or alternatively, said spatial position can be ascertained by:

a) detecting the spatial location of the optical coherence tomography scanner (10) or its emitting unit, in particular using a reference device and/or reference array (13) arranged on it, by means of the tracking system; and

b) determining the spatial position of the reference point with respect to the spatial location of the optical coherence tomography scanner (10) or its emitting unit, by means of optical coherence tomography.

Thus, the optical coherence tomography scanner itself can, but need not, be tracked in the tracking system. When ascertaining the location of the reference point, it can be in contact with the soft-tissue structure or can be arranged without contact above the soft-tissue structure. Different types of registration-assignment are also possible within the framework of the invention, one of which involves assigning discrete image values and in particular registering detected structure edges onto each other. Additionally or alternatively, it is possible to assign grey values of the image values when registering the spatially detected reference points to the stored image; this may be computationally more complicated, but enables an even higher registering precision.

The pointer unit of a medical image registration apparatus in accordance with the invention identifies or defines a reference point for assignment and/or indicates said reference point and comprises an optical coherence tomography (OCT) scanner and/or its emitting unit. It can also be composed of the optical coherence tomography scanner or its emitting unit, i.e. can substantially consist of it and/or form an integrated component.

As already indicated above in the discussion of the method in accordance with the invention, the pointer unit can be provided with a reference device and/or reference array which can be identified and/or locationally detected by a medical tracking system. However, this is not necessarily required if a suitable reference point detection method is chosen.

It is possible to equip the pointer unit with a data transfer device in order to transfer ascertained reference point location data to an evaluating unit, in particular an assigned medical navigation system. The data transfer device can be cable-connected or wireless (radio, Bluetooth, etc.).

In another preferred embodiment, the emitting unit of the optical coherence tomography scanner comprises an attachment, in particular an extended lens system, specifically an optical fiber lens system, wherein the optical fiber lens system can in particular be a rigid, elongated extending attachment. Using such an attachment, it is also possible to reach and register regions which are situated at points which are difficult to access from without in a direct line of sight, for example in the mouth cavity or nasal cavity.

### BRIEF DESCRIPTION OF THE DRAWINGS

The invention is explained below in more detail on the basis of example embodiments. It can comprise any of the features described here, individually and in any expedient combination.

FIG. 1 shows a schematic representation of an OCT scan on a patient's cranium.

FIG. 2 shows a magnification and schematic representation of the OCT beam reflection.

FIGS. 3 to 5 show schematic representations of different design variants for optical coherence tomography scanners.

### DETAILED DESCRIPTION

Firstly, the basic characteristics of optical coherence tomography will be discussed here, such as can be implemented within the framework of the present invention, i.e. in the method in accordance with the invention, in the pointer unit in accordance with the invention or in general terms when using an OCT apparatus in image registration. The features described in the following need not always be realized together, but can also be used alternatively, depending on the embodiment.

Optical coherence tomography such as can be used in accordance with the invention is a non-destructive imaging method which can display the internal structure of materials. By means of for example infrared light, it is possible to prepare a cross-section of a sample, i.e. for example a part of a patient's body, without contact and therefore non-destructively. The depth resolution can be 20 μm to 1 μm, and the physical principle is to interferometrically superimpose infrared light waves, which are scattered in different sample depths, with a reference wave. The reflected intensity contains the depth information of the sample and can be displayed as a cross-sectional image, once mathematical algorithms have been applied. In other words, optical coherence tomography involves making a topography of surfaces and structures visible in scattering media, by means of an optical interferometer which determines the scattering magnitude and the depth position of the structures to a high resolution.

Tissue structures can for example be displayed to a depth of 3 to 8 mm in the form of two-dimensional sectional images up through to the surface. The monochromatic light used has a very short coherence length, and when a sample is irradiated with this light, it is reflected on the surface and scattering processes occur in the sample which reflect a portion of the light. As already mentioned, this sample light is superimposed with the light of a reference plane, wherein an SLD having a short coherence length is used as the light source. Optical coherence tomography is therefore a form of short coherence interferometry.

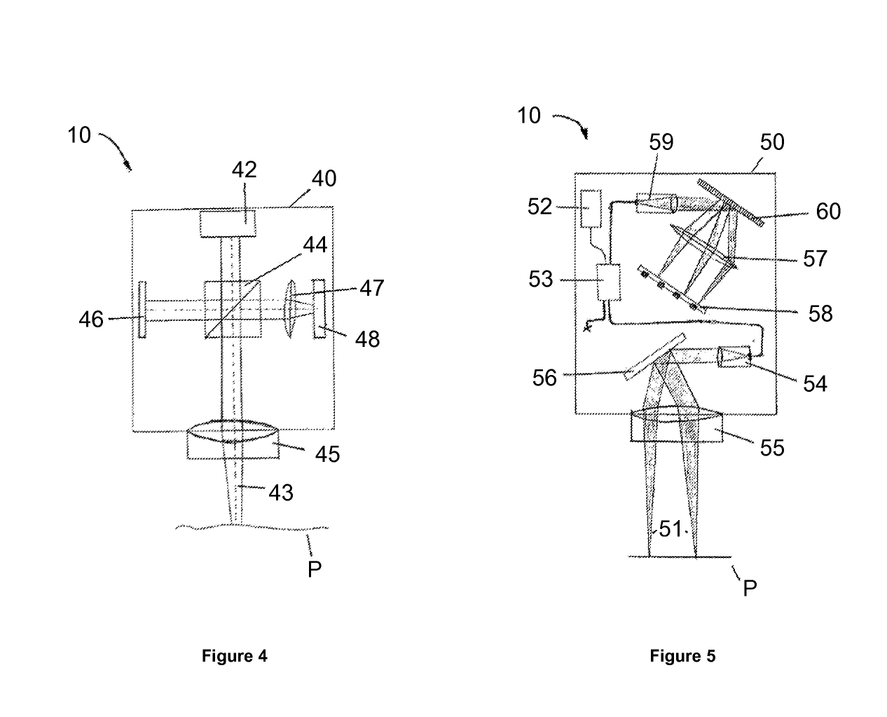

In order to explain basic embodiments of optical coherence tomography scanners, reference is initially made below to FIGS. 3 to 5. In each of these three figures, the optical coherence tomography scanner is indicated as a whole by the reference sign 10, and in FIG. 3, which shows a basic design, equipment features are also provided which integrate the tomography scanner 10 into a medical tracking and navigation system. These include for example a reference array 13 which—as already indicated above—can be provided but is not necessarily required (depending on the reference point determining method). For this reason, the connecting line has been punctuated by a wavy line in the representation. Another such feature relates to the data connection 31 which can be cable-connected or also wireless, as schematically indicated by the wireless symbol. Here, too, the data line shown is punctuated by a wavy line because both options are possible.

In the simple schematic design of the coherence tomography scanner 10 shown in FIG. 3, an SLD light generating unit is provided, i.e. a superluminescence diode which can for example generate light at a wavelength of λ=1280 nm and a coherence length of about 20 μm. The SLD 32 radiates its light through a beam splitter (for example, a semi-permeable mirror), and a portion—the OCT beam 12—reaches the sample P and is reflected from different planes (the beam 14). The beam 14 then hits the beam splitter 34 again and is deflected by it onto the detector 38. The reference beam 15 passes from the beam splitter directly onto a mirror 36 and, through the beam splitter 34, also to the detector 38. The reflected light of the OCT beam 12, 14 is thus superimposed with the light of the reference beam 15. An interference signal is created when the wave trains of the reflected light are superimposed with those of the reference beam within the coherence length. Due to the greater difference in distance, repeatedly scattered light does not have a defined phase relationship with respect to the light of the reference beam and does not therefore contribute to the interference signal. Thus, only light which has been scattered once is processed from a defined tissue depth. The shorter the coherence length, the better the resolution capacity of the method. It becomes possible to display a depth profile, because all the light waves which obscure the light which has been scattered once are eliminated. The interference signal is a measure of the magnitude of scattering in the corresponding tissue depth. The irradiation depth is limited by the scattering characteristics of the tissue.

By continuously varying the length of the reference beam, a depth profile of the backscattering intensity at one point of the tissue is thus created. By laterally deflecting the beam over the surface of the tissue, two-dimensional sectional images are created.

The data received at the detector can then be forwarded via the data line 31 for evaluation, or can be evaluated by an integrated evaluating unit and forwarded as finished depth data and/or sectional image data.

The design of the coherence tomography scanner 10 of FIG. 4 differs in that the SLD 42 in the housing 40 emits a broad beam 43 through the beam splitter 44, which is focused by a lens 45 before it hits the sample. The reference beam, which is reflected by a mirror 46, and the reflected OCT beam 43 are likewise focused by a lens 47 before they hit the detector 48. By moving the mirror 46 horizontally from left to right, it is possible to alter the penetration depth of the beam 43 into the tissue P.

FIG. 5 shows another embodiment of an optical coherence tomography scanner, in which the light is generated in the tomography scanner 10 in the housing 50 by the SLD 52 and then enters a fused-fiber phase coupler 53, from which it is guided via the collimator 54 to the galvanometer scanner 56, split, guided through the lens 55 and radiated to the sample P as OCT beams 51. These are returned through the corresponding components in reverse and then via another collimator 59, the grid 56 and the lens 57 onto the detector 58. By altering the angle of inclination of the galvanometer scanner 56, it is possible to alter the location of the beam 51 on the surface of the sample P.

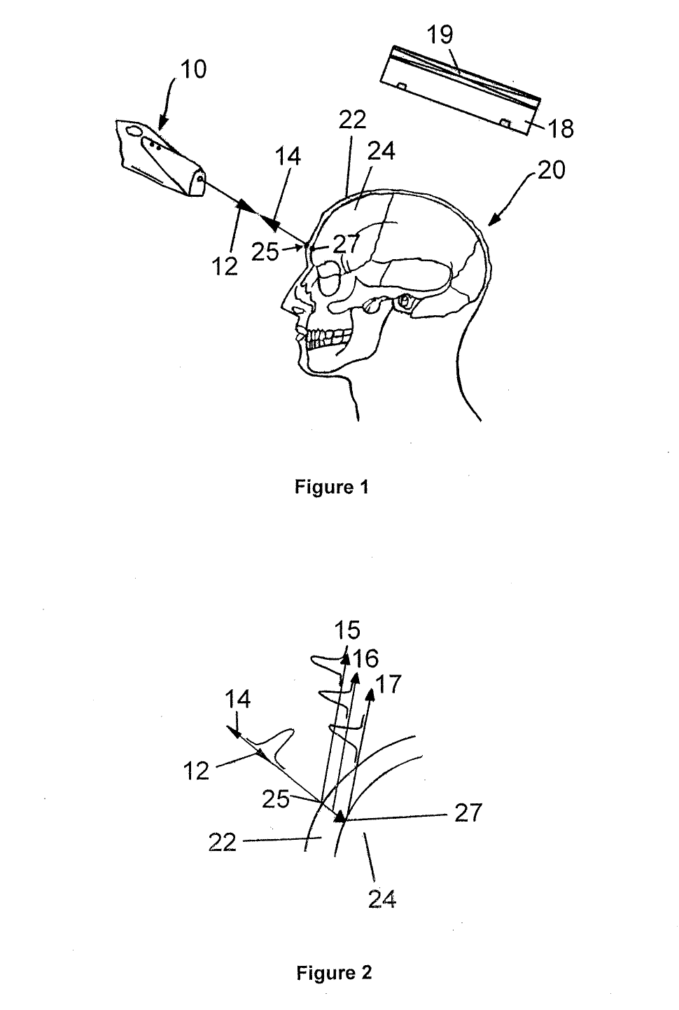

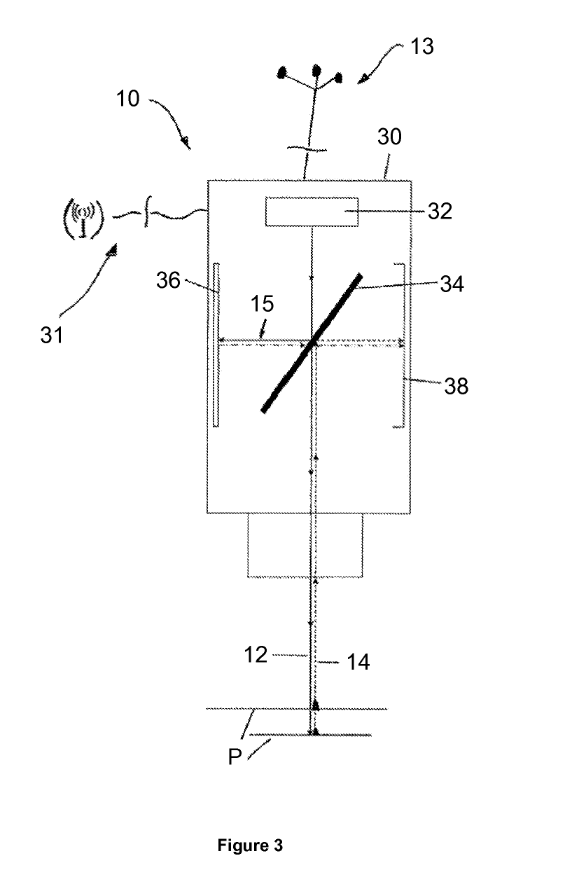

The use in accordance with the invention can then be gathered schematically from FIGS. 1 and 2. FIG. 1 shows a patient's head 20, i.e. the part of the patient's body as referred to above. In a simplified form, it consists of the osseous cranium 24 and the skin 22 above it, and the patient's head 20 is then to be registered using the reference tomography scanner 10, with the aid of the integrated navigation and tracking system 18, 19 which can locationally detect optical signals, wherein it is locationally assigned to a previously produced image data set which is for example derived from a CT or MR image capture.

In the method shown in FIG. 1, the coherence tomography scanner is not provided with a reference array, i.e. it can be freely moved and is not localized by the tracking system 18. It emits the OCT beam 12 which hits the head 20 and is reflected.

In order to illustrate this, reference is now made to FIG. 2, which shows the incident beam 12 which is reflected in different ways, as indicated merely in principle here by the returning beams 15, 16 and 17. Each of the beams 15, 16 and 17 indicates a lateral proportion of the returning beam in FIG. 2, in order to illustrate the different reflection planes and/or layers. For evaluation when determining the depth of the reference point 27 on the osseous cranial structure, however, the returning beam 14 which returns counter to the OCT beam 12 is of course processed in the coherence tomography scanner 10 (see FIG. 3). However, the representation in FIG. 2 shows how the OCT beam 12 generates different returning and/or reflection beams 15, 16 and 17 in different planes, and this enables a depth profile to be produced. The in fact obliquely reflected beam 15, which represents a light point 25 on the upper side of the skin, is also of specific interest for a type of registration in accordance with the invention which is chosen here, since this light point on the upper side of the skin can be detected and locationally categorized by the tracking system 18, from which alone the tracking system provides an absolute spatial point (having determined spatial coordinates), which together with the depth information for the point 27 from optical coherence tomography then allows its location to be very clearly detected and registered. Although the point 25 is again a reflection point on the skin, this information precision is sufficient because the actual registration is based on the “hard” values for the osseous cranium and its surface. A corresponding registration-matching of surfaces obtained by a plurality of OCT points of the cranial bone (the points 27) will thus deliver the greatest precision, while the information on the location of the reflected light point 25 serves as a starting aid for assignment within the computer-assisted matching method.

If, as shown as an option in FIG. 3, a reference array 13 is arranged on the tomography scanner 10, the “detour” via the light point 25 does not necessarily have to be made. The location of the tomography scanner 10 and therefore of the light source and/or light exit point would then be known, and it would only then be necessary to add to this location the depth information from optical coherence tomography, in order to be able to directly localize the reference point 27.

Computer program elements of the invention may be embodied in hardware and/or software (including firmware, resident software, micro-code, etc.). The computer program elements of the invention may take the form of a computer program product which may be embodied by a computer-usable or computer-readable storage medium comprising computer-usable or computer-readable program instructions, “code” or a “computer program” embodied in said medium for use by or in connection with the instruction executing system. Within the context of this application, a computer-usable or computer-readable medium may be any medium which can contain, store, communicate, propagate or transport the program for use by or in connection with the instruction executing system, apparatus or device. The computer-usable or computer-readable medium may for example be, but is not limited to, an electronic, magnetic, optical, electromagnetic, infrared or semiconductor system, apparatus, device or medium of propagation, such as for example the Internet. The computer-usable or computer-readable medium could even for example be paper or another suitable medium on which the program is printed, since the program could be electronically captured, for example by optically scanning the paper or other suitable medium, and then compiled, interpreted or otherwise processed in a suitable manner. The computer program product and any software and/or hardware described here form the various means for performing the functions of the invention in the example embodiment(s).

Although the invention has been shown and described with respect to one or more particular preferred embodiments, it is clear that equivalent amendments or modifications will occur to the person skilled in the art when reading and interpreting the text and enclosed drawing(s) of this specification. In particular with regard to the various functions performed by the elements (components, assemblies, devices, compositions, etc.) described above, the terms used to describe such elements (including any reference to a “means”) are intended, unless expressly indicated otherwise, to correspond to any element which performs the specified function of the element described, i.e. which is functionally equivalent to it, even if it is not structurally equivalent to the disclosed structure which performs the function in the example embodiment(s) illustrated here. Moreover, while a particular feature of the invention may have been described above with respect to only one or some of the embodiments illustrated, such a feature may also be combined with one or more other features of the other embodiments, in any way such as may be desirable or advantageous for any given application of the invention.

What is claimed is:

1. A medical image registration method in which an actual part of a patient's body is locationally assigned to a stored image of the part of the body with computer assistance, wherein the part of the patient's body comprises a rigid structure and a soft-tissue structure above it, wherein the location of at least one reference point on the rigid structure is ascertained, through the closed soft-tissue structure, by means of optical coherence tomography (OCT), when detecting the actual spatial location of the part of the body.

2. The method according to claim 1, wherein the actual spatial location of a plurality of reference points, a scatter plot of reference points, linearly adjacent reference points or adjacently spaced reference points is determined.

3. The method according to claim 1, wherein the rigid structure is an osseous structure or a cartilage structure.

4. The method according to claim 1, wherein the soft-tissue structure is a skin structure.

5. The method according to claim 1, wherein the spatial locations are detected with the aid of a medical, optical tracking system.

6. The method according to claim 5, wherein registration is performed by a medical navigation system which the tracking system is assigned to.

7. The method according to claim 1, wherein an OCT beam is radiated onto the part of the patient's body by an optical tomography scanner or its emitting unit.

8. The method according to claim 1, wherein the spatial position of the reference point on the rigid structure is ascertained by:
a) spatially detecting the OCT beam reflection point corresponding to it on the outside of the soft-tissue structure, by means of the tracking system; and
b) determining the depth position of the reference point beneath the reflection point, by means of optical coherence tomography.

9. The method according to claim 1, wherein the spatial position of the reference point on the rigid structure is ascertained by:
a) detecting the spatial location of the optical coherence tomography scanner or its emitting unit by means of the tracking system; and
b) determining the spatial position of the reference point with respect to the spatial location of the optical coherence tomography scanner or its emitting unit, by means of optical coherence tomography.

10. The method according to claim 9, wherein the spatial location of the optical coherence tomography scanner or its emitting unit is detected using a reference device and/or reference array arranged on it.

11. The method according to claim 1, wherein when ascertaining the location of the reference point, the optical coherence tomography scanner or its emitting unit is in contact with the soft-tissue structure.

12. The method according to claim 1, wherein when ascertaining the location of the reference point, the optical coherence tomography scanner or its emitting unit is arranged without contact above the soft-tissue structure.

13. The method according to claim 1, wherein when registering the spatially detected reference points to the stored image, discrete image values are assigned.

14. The method according to claim 13, wherein detected structure edges are registered onto each other.

15. The method according to claim 1, wherein when registering the spatially detected reference points to the stored image, grey values of the image values are assigned.

16. A pointer unit of a medical image registration apparatus, with the aid of which an actual part of a patient's body is locationally assigned to a stored image of the part of the body with computer assistance, wherein the pointer unit identifies and/or indicates a reference point for assignment, wherein the pointer unit comprises an optical coherence tomography (OCT) scanner or its emitting unit.

17. The pointer unit according to claim 16, wherein it is composed of an optical coherence tomography (OCT) scanner or its emitting unit.

18. The pointer unit according to claim 16, wherein it is provided with a reference device and/or reference array which can be identified and/or locationally detected by a medical tracking system.

19. The pointer unit according to claim 16, wherein it is provided with a data transfer device, in order to transfer ascertained reference point location data to an evaluating unit.

20. The pointer unit according to claim 19, wherein the data transfer device is a cable-connected or wireless data transfer device.

21. The pointer unit according to claim 19, wherein the evaluating unit is an assigned medical navigation system.

22. The pointer unit according to claim 16, wherein the emitting unit of the optical coherence tomography scanner comprises an attachment.

23. The pointer unit according to claim 22, wherein the attachment is an extended lens system.

24. The pointer unit according to claim 23, wherein the extended lens system is an optical fiber lens system.

25. The pointer unit according to claim 24, wherein the optical fiber lens system is a rigid, elongated extending attachment.
